(19) United States
(12) Patent Application Publication
(10) Pub. No.: US 2017/0300849 A9
(43) Pub. Date: Oct. 19, 2017

(54) Shift Trader Mobile Application

(71) Applicants: Jake Pike, Los Angeles, CA (US); Robert Arrata, Los Angeles, CA (US)

(72) Inventors: Jake Pike, Los Angeles, CA (US); Robert Arrata, Los Angeles, CA (US)

(21) Appl. No.: 14/743,997

(22) Filed: Jun. 23, 2015

Related U.S. Application Data
(60) Provisional application No. 61/998,127, filed on Jun. 19, 2014.

(51) Int. Cl. G06Q 10/06

(52) U.S. Cl. CPC G06Q 10/063116

(57) ABSTRACT

A mobile application allowing peer to peer communications for trading and scheduling of employment scheduling needs. Allows users to post, trade, swap, schedule shifts, sick days, vacation, overtime, and other scheduling needs, in real time, based on a customized profile.

### PRIORITY CLAIM

This non provisional patent application claims the benefit of priority to pending U.S. provisional patent application entitled, “SHIFT TRADER MOBILE APPLICATION”, filed Jun. 19, 2014, having Ser. No. 61/998,127 and is incorporated by reference in its entirety.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING A TABLE OR A COMPUTER PROGRAM LISTING COMPACT DISK APPENDIX

Not Applicable

### BACKGROUND OF INVENTION

Employee-need based and employee-to-employee scheduling models are not being met by current scheduling technology and other scheduling methods, especially those in shift work or flexible scheduling industries. Employees and staff are the human factor of an organization in all industries, in both union and nonunion settings. Scheduling needs and changes in those needs made without the current scheduling methods are done at the employee level. Scheduling needs changes made at the employee level are not served by these current methods.

The current scheduling technology models for employees of all industries where the scheduling of shifts, overtime, vacations, sick day, and other types of scheduling gaps is based on management and/or organization need. These current software models are designed to create employee scheduling based on the specific needs of the organization/management. These models create a scheduling profile to create a schedule that allows the organization to operate at its most efficient level. Common to most industries, these programs take into account the parameters including: customer flow, customer demographics, cost efficiency, revenue streams, customer activity, call/event activity, and event flow. These schedules are made on a weekly, monthly, bi-monthly, or other duration.

The second method used by organizations is the independent creation of schedules by supervising managers or others in charge of scheduling via calendars, spreadsheets, or lists. There is no data or parameter calculation for efficiency, based on human calculation alone of where employees would be most efficient and needed. This method is commonly seen in smaller businesses or organizations that do not have the financial resources to invest in scheduling software. The current software technology models are used in organizations of 50 or more. In both methods, scheduling needs are based on management and/or organization needs, not taking into consideration the requirements or changes by employees.

These models comply to business generated parameters, not accounting for the human need for scheduling changes based on schooling, family, medical, or other needs. The lack of focus on the employee side of scheduling changes creates inefficiency in the running of the organization. It also creates extra costs, loss of production, redundancy, and employee turnover.

There are several problems with scheduling need changes at the employee level that these current models and methods do not address. Shift exchanges or gap coverages are not calculated in the same way as the original schedule is, requiring either the employee or supervisor to find an underqualified substitute. The supervising manager or scheduler may not approve of the request based on lack of finding coverage. Employees have to rely on inefficient methods to fill gaps, which do not reach qualified members of the organization. The requirement of these scheduling programs to be accessed only via computer and the necessity of Wi-Fi renders changes to scheduling needs over-burdensome. Mobile websites featuring the request are also time consuming to access and do not provide ease of access for employees.

As illustrated above, the current scheduling models create an organization's scheduling based on its need, they do not consider an employee's needs for changing a generated schedule. Because the current models do not address employee need, there are routinely two methods organizations use for gap coverage; a supervisor finding a replacement, or an employee. For those organizations where a supervisor or scheduling manager is required to find a replacement, hours of productivity are wasted. Even with the use of current scheduling models at best there is a generated database of employees. The standard course of business involves the use of a call list or spread sheet, where an employee's personal information is listed in the data, along with basic information. This basic information may include regular shift days; to avoid applying overtime in compliance with the Fair Labor and Standards Act or other applicable labor laws, seniority date; if an organization has a Collective Bargaining Agreement where seniority is a component of shift selection, and potentially a preference of shift. These call lists are not generated based on the organization's needs that were used in the creation of the original schedule.

As a supervisor or scheduling manager's call list is not based on the same criteria as the original scheduling needs, problems are created in finding adequate gap coverage. Based on the gap needing coverage, employees may not accept the shift based on lack of certification or knowledge of the skill involved with the shift, or they will provide coverage for the shift and will perform inefficiently or inadequately. For those shifts that do not require a specific training but a preferred skillset or other generic value set, an employee may not choose to do the shift out of time management of their daily life. If the site is unionized and seniority date is a parameter for shift coverage, the organization puts themselves at risk for grievance actions by not applying that need in the gap coverage. Other issues regarding a supervisor call list is employees may decide not to answer the phone because they don't want to provide coverage, knowing if they answer they will likely be ordered to fill the scheduling need.

Supervisors and scheduling managers tasked with finding gap coverage for scheduling needs spend countless extra hours during their work week on this task. This decreases their productivity in other areas of their job function. Further, both supervisors and employees are limited by this method as it requires both groups to be consistently connected to each other via phone or email. While a supervisor may text a large group of employees for coverage, the most qualified employees are not ensured to get the text message, nor are they likely to be awarded the shift, unless they. answer the text message first. This type of communication is especially sensitive to a collective bargaining agreement where seniority dates rule. This method is also inefficient for the supervisor, especially in unionized industries as the supervisor cannot award gap coverage to a responding employee unless they have receive all responses and are able to compare them with seniority dates. This creates last minute scheduling needs changes that may remain unfilled. It is also problematic for employees as they are required to keep themselves close to their phones or email, which may not be possible. This inability renders them unable to accept a shift, or in the case of unionized industries, they may not find out until last minute their scheduling change request has been denied, well after the point of them being able to keep their original schedule.

Where an employee must find coverage for scheduling needs, the current methods are antiquated and do not reach the entire population. There are two primary ways in which an employee may find coverage, personal relationships or social media. In regards to personal relationships, the employee's personal network is utilized, namely in the use of either speaking to colleagues directly at the work site, speaking over the phone or texting. All three methods rely on the employee's knowledge of the people they work with. In organizations of all sizes, an employee's knowledge base is not as large as the organization's itself. This means that the employee does not possess the contact information of all members in the organization, only those to which they routinely work with, or have a personal relationship with. This lack of contact information creates issues, as employees may not have the ability to contact a person who fills the requisite need for the coverage of a scheduling need, or they may overlook employees who are willing to accept the coverage.

The use of social media requires that all employees are regularly logged into their accounts to see the posted shifts. Social media accounts like Facebook and Twitter require an employee to have an account in order to join a respective page to post or accept the changes. For those employees who do not have or do not want to have social media accounts, they are unavailable to accept coworker's schedules. This lack of conformity, as with the personal relationship method, overlooks several coworkers who might otherwise be available to accept a scheduling need.

These models are computer or mobile website based, and require the employee to log in to see the weeks shift schedules if they are away from a posted work site. This requires a person to have access to their computers and Wi-Fi along with their computer or lap top on hand with them regardless of their location. For those organizations that email their future scheduling to their employees, they require that the employees has constant access to their email accounts as well as smart phone capabilities that will allow them to open files, where the connection may or may not work, or based on configurations and attachments, may not open.

A further problem with current scheduling models is the requirement of these scheduling systems to be accessed by a website or mobile website. Accessibility by both sites requires that employees, along with management to have consistent access to a computer or laptop or a smartphone with Wi-Fi capabilities. The use of either to see schedules and changes to scheduling needs requires employees to have access to a computer, which is an inconvenience for employees out of the worksite, and based on login time outs does not allow employees to see if their request for changes have been accepted until the last minute. This is problematic for the employee if their required change is not covered or accepted.

For those scheduling models that have a mobile website, these sites are not compatible with every smartphone browser. Further, they have limited capabilities based on the smartphone using the site, and may not load properly, or be unable to be logged into. As they are not built to be specifically used for one type of smartphone, they are often too small for an employee to view properly and hard to use based on their sizing. This frustrates workers to not use this option for their scheduling changes and needs.

Both traditional websites accessed via laptop, and mobile websites accessed via a smartphone or tablet, share another component that creates inefficiency for scheduling changes. They require that they have connectivity to Wi-Fi to be accessed. If employees are in areas that do not have Wi-Fi capability or unreliable Wi-Fi capabilities, they are unable to access these current models to determine if scheduling changes have been made or accepted.

Unlike how the original schedule is created based on specific needs of the organization to maximize efficiency, finding gap coverage is not governed by the same criteria. Supervisors using call lists do not have separate lists based on the certificates, skills, qualifications, or other parameters to find gap coverage. If a replacement is found for the open shift, the coverage is underqualified based on the lack of specific criteria. An underqualified replacement for a shift creates inefficiency, underperformance by that employee or coworkers, or increased liability.

The same problem is present in employee found coverage. The use of calling, text messaging, social media, and other methods by coworkers is not based on the needed qualifications of the original schedule. The use of these methods are sent out to all coworkers or sent to coworkers an employee knows personally, not based on the particular characteristics needed for the scheduling need. As most scheduling needs require the approval of a supervising manager, the manager has the details needed for the coverage of the scheduling change. If the colleague who accepted the shift does not possess the qualifications needed for efficient shift coverage, the request can be denied. Coupled with the hours or days it takes for a coworker to find shift coverage, a last minute denial of a shift change creates inefficiencies and extra costs.

Lastly, after a scheduling change has been accepted, the employee and/or supervisor are responsible for calendaring the change. The current technology and methods to not allow for the employee's or scheduler's responsibility to be overridden. At most these methods send an email noting the change. However, this does not ensure the shift change will be filled as there is no mechanism to resolve the human factor of forgetfulness.

### BRIEF DESCRIPTION OF VIEWS OF DRAWINGS

FIG. 1: Shift Board. Where all available scheduling needs based on the users profile will be posted and available for viewing and acceptance.

FIG. 2: Registration Screen for new members. This is the first field requirement in order to access Shift Trader.

FIG. 3: Log in screen for existing members. This screen appears when the application opens once the user has set up their login registration.

FIG. 4: Settings Page (My Profile). This is the profile page a user must complete before they can accept, post, or view scheduling needs.

FIG. 5: Welcome Screen for new users of Shift Trader. The welcome screen directs new users to set up their profile.

FIG. 6: Detail View. This is the detailed view of the posting of the scheduling need, including all essential information.

FIG. 7: Acceptance of Shift. This message appears when a user selects to accept a scheduling need. This page is the confirmation of the acceptance of the shift.

FIG. 8: Shifts I Accepted. This page lists the scheduling needs a user has accepted. The detail indicator can be tapped to show details of the accepted scheduling need.

FIG. 9: Shifts I Accepted Detail view. The details of the accepted scheduling need, including the contact information of the posting user.

FIG. 10: Shifts I Posted page. Lists the scheduling needs a user has posted as well as function to create and post new scheduling needs.

FIG. 11: Post New Shift. This is the view of the details of the scheduling need as well as the contact information of the posting user.

FIG. 12: Shift I Posted Detail View. The detail indicator on the screen will show the details of the scheduling need posting. If the scheduling need is accepted, the contact information of the accepting user will be present.

FIG. 13: Delete a shift. This action allows a user to delete a scheduling need they post from the shift board.

FIG. 14: Shift Trader Creation flow. The page flow of Shift Trader demonstratively illustrated by the sudo code.

### DETAILED DESCRIPTION OF INVENTION

### Overview

A real time, peer to peer communications mobile application for the purpose of creating, posting, viewing, and accepting, scheduling needs comprising of trading, swapping, exchanging, shifting, and gap filling. Scheduling needs comprises of shift trading, or coverage, overtime assignment, sick day scheduling, substitutions, temporary assignments, posts, positions, and vacation scheduling. Shift Trader may be used in any industry in unionized and unionized organizations regardless of the size of the organization. Its customized profile, creates the parameters which allow users to view, post, create, and accept scheduling needs. This customizable profile may be tailored to fit an unlimited range of required fields, as small or as large and an organization needs. The customizable combination of fields in the profile is limitless in combination.

How Shift Trader Solves these Problems

Shift Trader solves the problems unresolved by current scheduling technology though peer to peer communication at all levels on a customized platform. As a mobile application, Shift Trader gives employees consistent and constant access to limitless scheduling needs; comprising of the posting, viewing, and accepting, and their organization. All posting, viewing, accepting, organizing, and calendaring, changes, and communications via the Shift Trader Mobile Application are peer to peer and made in real time, using Cloud technology.

A login is required to access the application in order to keep the information secure. Unlike a log in requirement via a website or mobile website to obtain access, Shift Trader is accessible from the users smartphone from any location regardless of Wi-Fi availability. The data and platform for scheduling needs is self-contained in the mobile app itself.

As a real time, peer to peer communication tool, Shift Trader eliminates the need for outdated gap coverage by supervisors and scheduling managers of call lists, spreadsheets, and calendars. Supervisors can be integrated directly into Shift Trader to communicate directly with employees after the employees have found coverage for their scheduling need. This option allows for the immediate notification of a scheduling change, ready for the supervisor's approval if needed. Shift Trader focuses on the need of employees to find adequate and acceptable coverage for scheduling needs without managerial interference. Particularly useful in unionized industries, worksites, and organizations, Shift Trader allows for employees to find proper coverage while in compliance with collective bargaining agreements comprising of seniority dates and work rules.

The customized profile tailored to individual industries and organizations comprises of the needs, specifications, certifications, seniority dates, work rules, and other organization specific parameters which creates a profile that facilitates in the efficient and effective creating, posting, and accepting of scheduling needs. Unlike the current models and methods which are indiscriminate in gap coverage and result in employees being unable to have their needs fulfilled and decrease the efficiency and performance of organizations. These parameters sort the scheduling needs so that only those users who have the matching customized fields of the scheduling needs will be able to accept. This mobile application uses Cloud technology to allow users to create and accept scheduling needs in real time, which reduces the time it takes to find gap coverage. This decrease in the time to find coverage assists organizations and employees to comply with state and federal labor laws.

Shift Trader allows users to communicate scheduling needs within their organization based on customized parameters to ensure their scheduling needs are met with an almost identical skill set or qualifications. It also assists the management side of an organization by being able to have scheduling gaps filled with qualified persons, preventing a shift gap in skill, certification, or need. Shift Trader can reach the whole organization, or those users who are compatible with a specific set of parameters, completed in the profile. The application can be customized to any size of organization, and any industry.

Communication and organizing inefficacies of the acceptance of the shift change by the accepting user is resolved by Shift Trader. Rather than the accepting employee of a shift being responsible for calendaring the accepted change, Shift Trader immediately sets up an event on the user's smartphone calendar, which includes setting an alarm at least 24 hours prior to the accepted scheduling need.

### Application and Functionality

The applications and functionality of Shift Trader Mobile App are focused on and comprise of the collection, capture, posting, trading, swapping, exchanging, calendaring, and calendaring of scheduling needs. Additionally comprise of any scheduling allowances described in local, state, and Federal labor and wage hour laws. Scheduling needs comprises of shift trading, or coverage, overtime assignment, sick day scheduling, substitutions, temporary assignments, posts, positions, and vacation scheduling.

As a peer to peer communications tool, schedule needs are addressed and responded to in real time. Two types of users can use the application, employees and supervisors. Shift Trader focuses on employee to employee communication, however the application can be expanded to customize in its platform to incorporate supervisors, schedulers, management, or other representation in charge of scheduling. This comprises of supervisors being communicated to via email, app communication, or text message by Shift Trader after a scheduling need has been accepted by a user, or a supervisor may post, view, and accept an employee request for a shift of change or scheduling need.

All industries will find several benefits, having productivity, efficiency, and cost value and the current and future problem solving benefits by using Shift Trader. The application is not exclusive to any industry. It is applicable and has value to all industries where schedules comprising of shifts, work hours, and temporary assignments are scheduled, exchanged, traded; as required or allowed by workplace policy, local, state, or federal statute or law, management of sick days, management of personal days, overtime scheduling, and/or vacation scheduling. All nonunionized and unionized comprising of industries, work sites, departments, facilities, companies, organizations, or groups, can get functionality from use of the application.

The customized profile is pivotal to the functionality and application of Shift Trader and is calibrated to limitless combinations unable to be described in its entirety. The customized profile is the manner in which a user communicates their scheduling needs between other users. The customized profile contains required fields found in every industry and organization, which is comprised of personal information and general data. The personal information having name, email, phone number, position, work week duration, and location. All remaining fields are customizable to the specific needs of the industry or organization. As the capabilities and application are available to limitless industries, the following industries demonstrate the expansive industries and customizable parameters Shift Trader is applicable to. The industries Shift Trader is applicable to comprises of Public Safety, Healthcare, Education, Construction, Restaurant, Retail, Transportation, Temporary Services, and Manufacturing. As the combination of industries and required fields for the customized profile are limitless in scope, it is impractical to list all alternative industries and fields those industries require.

Public Safety comprises of Fire and Rescue, Paramedics, emergency medical technicians (EMT), Ocean and River Lifeguards, and Police. These organizations are applicable in both career (paid) and volunteer. The customizable profile features comprises of location; not exclusive of station, outpost, court, or court system, department, position designation; having designations of Firefighter, Paramedic, EMT, Chief, Captain, Battalion Chief, and/or other organizational specifications of similar positions, shift side, shift schedule, certification, skill background, shift start preference, applicable collective bargaining work rules.

Healthcare comprises of Physicians, Nurses, Physician's Assistant, Nurse Practitioner, Technicians, Home Care Aids, Caregivers, and Medical Assistants, having Private, Public, Hospital network, Accountable Care Organization (ACO), Patient Centered Medical Home (PCMH), co-op; and group practice applicability. The customizable profile features comprises of: location, provider contract, certification, hospital system, specialty, shift side, shift schedule, unit number, department preference.

Education comprises of Teachers, Substitute Teachers, Student Teachers, Teaching Assistants, and Teacher's Aids, having private, public, and religious schooling systems, elementary, primary, secondary, middle school, high school, undergraduate, and post graduate applicability. The customizable features comprises of credentials, certifications, taken tests, safety requirements, school district, grade level experience, grade level preference, school location.

Construction comprises of Contractors, Laborers, Plumbers, Electricians, Project Managers, Roofers, Structural Engineers, General Construction, and Day Laborers having applicability in all manner of construction activities. The customizable features comprises of location, trade, skill set, language proficiency, shift side, and shift duration.

Restaurant industries comprises of Wait Staff, Kitchen Staff, Managers, Hosting Staff, Bartenders, having applicability in independent organizations and chains. The customizable features comprise of location, language proficiency, shift preference, shift side, and duration.

Retail comprises of Sales, Managers, and other staff, having applicability in department stores, boutiques, co-ops, brick and mortar storefronts, and kiosks. The customizable features comprise of location, department area, language proficiency, shift preference, shift side, skill specialties.

Transportation comprises of railroad, public transportation, and airline, having applicability of all position designations of each industry. Not exclusive to the description, each industry may contain dozens or hundreds of position names independent of each organization, department, yard, and company. Due to the size of the positions descriptions they are not contained therein. This description encompasses all current and future position descriptions, designations, or names. The customizable features comprise of location, yard, company; having railroad, airline, bus line, or metro line, shift side, day or night side, work week split, and certifications, routes, work rules, specialty, seniority date, policies, safety and FRA rules.

Temporary Services comprises of any industry with temporary positions that require filling, temporary agencies requiring position filling, and organizations that need temporary workers. The customizable features are unique to the industry, comprising of any relevant data for the temporary field.

Manufacturing comprises of all industries where goods are produced, either domestically or internationally, having Line Workers, Assemblers, Assembly Line Managers, Quality Control, Packaging and Shipping. The customizable features comprise of shift preference, shift side, line side, and skill set.

Non-unionized industries, having businesses and organizations, will have added value using personal information and general data as a groundwork. Additional fields will be dependent and variable based on industry, business, organization, department comprised of regional, local, statewide, or national, rules, procedures, standards, policies, employee handbooks, job descriptions, and differentials. Agreements dictating any work rules or specification may be included in the customized profile.

Unionized industries, having businesses and organizations will in addition include required fields based on Collective Bargaining Agreements. The required fields based on Collective Bargaining Agreements comprise of seniority date, work rules, amendments, procedures, and policies. The combination of components detailed in collective bargaining agreements are limitless in nature and vary in broad and narrow construction. Multiple collective bargaining agreements and their components can be combined or separated in the customized profile.

The foregoing described embodiments are intended to be illustrative of specific applications of the present disclosure. It would be impossible to list every potential application herein, however, other similar applications are within the spirit and scope of the present teaching.

### Application and Functionality—Illustrative Example.

The described embodiments are intended to be illustrative of specific applications of the present disclosure. It would be impossible to list every potential application herein, however, other similar applications are within the spirit and scope of the present teaching.

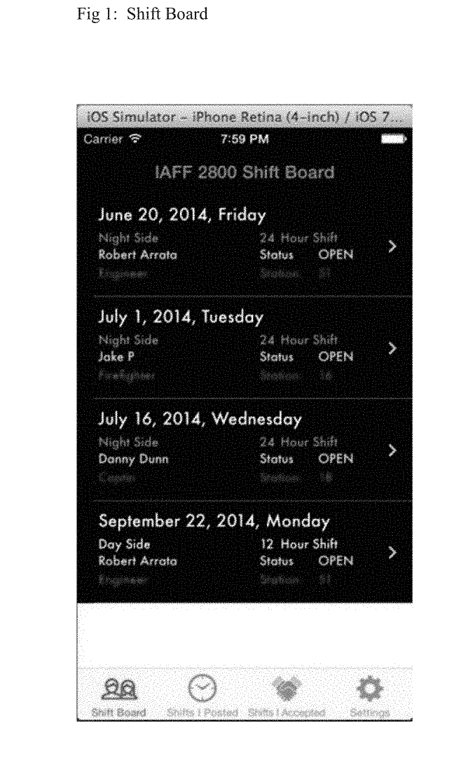

The functionality of Shift Trader focuses on end user application. Users of the application can post and view available shifts in real time (FIG. 1). As the post is uploaded or a position is accepted, all users in the specific parameter specification based on the profile completion, will be notified that a shift is or is not available. In uses where a supervisor or other scheduling manager has control of the schedule, the shifts are posted to the application where end users can see the shifted posts based on their profile.

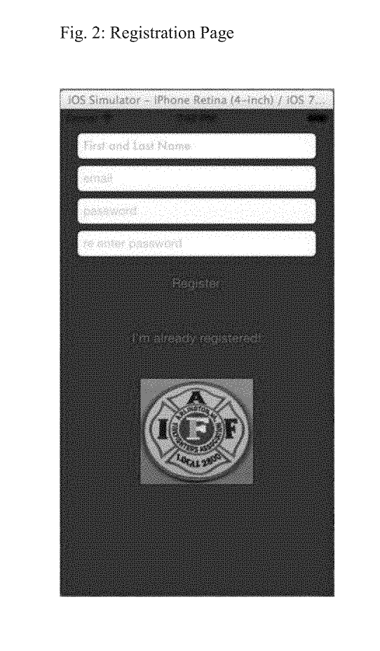

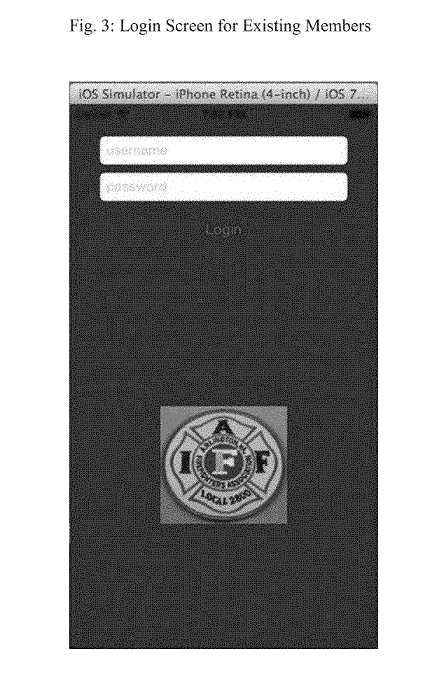

As the user downloads the application on their smartphone, the first screen the user will see in order to access Shift Trader's contents is the registration page (FIG. 2). This page has required fields the user must fill in, the username, email address and password. Once the fields are filled in and the information has been accepted, the user will have access to the application. If the user has already completed the registration page the application will require them to select “I am already registered” (FIG. 3). The user will then be directed to the login screen for access to the application, or if within the time constraints access directly to the content.

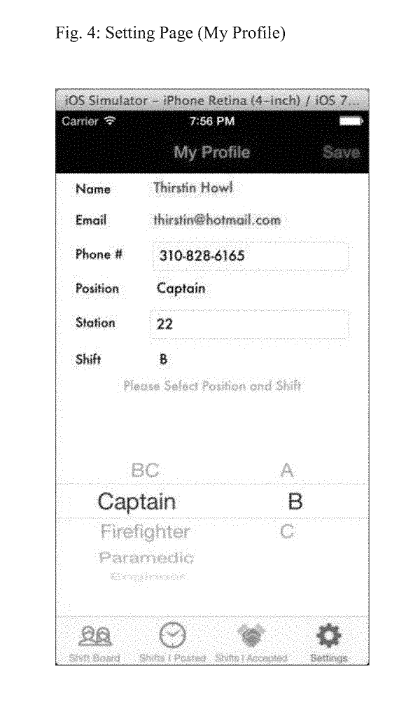

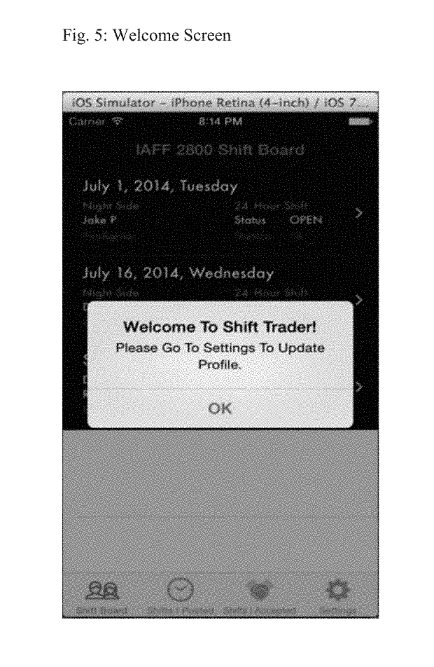

The primary functionality of Shift Trader is centered on the creation of a profile customized to a particular industry or organization (FIG. 4). When a user first downloads the application, before any scheduling changes or viewings can be made, the user must complete a profile. The user will know that they have to complete a profile because they will be directed to the “Welcome” Screen (FIG. 5). A message will appear directing the user to “Settings” to complete a profile. For existing users this message will not appear and they will be directed to the Shift Board. This profile is determined by the organization and industry.

The profile and its categorical parameters are set based on specific characteristics unique to the operating organization. The parameters are tailored to be as broad or narrow as required by the users and the organization they work for. These parameters can be programmed to distinguish similar employees by certifications, shift type (day, night, 8, 10, 12, 24 hour shifts), language requirements, position, location, and skill set. Additionally for those organizations who are under specific agreements and collective bargaining agreements, the parameters can be adjusted for particulars under work rules and seniority based models. The profile field can be generated to have as many fields as necessary and can be cross referenced so that users may be eligible for more than one type of shift. Meaning, as an illustrative example, if shifts that need to be completed have 1 or 2 profile features required for adequate gap filling, and a profile has 20 different fields on completion, that shift will not require all 20 for a user to be able to view, post, or accept the shift.

For those profiles needing compliance to collective bargaining agreements comprising of seniority, the acceptance of a posted shift, overtime scheduling, or vacation availability can be based on a seniority selection parameter. This characteristic allows for the collective bargaining agreement to be adhered to. For those organizations that require a supervising body to ensure the seniority date is accurate, a check of the profile can be done prior to acceptance of a post. If a governing collective bargaining agreement is predicated on seniority being the key determining feature for the acceptance of scheduling changes, overtime scheduling, or vacation scheduling, Shift Trader can be configured to include a preloaded profile with a confirmed seniority date to avoid grievances or complaints filed over a violation of a collective bargaining agreement's seniority. After the completion of the profile, a user may then begin to post, view, and accept shifts and other scheduling needs (FIG. 1)

The first page of Shift Trader Mobile App is the “Shift Board” (FIG. 1). The “Shift Board” allows those users who fit the proper profile characteristics to view the available shifts or scheduling needs. The scheduling needs are listed on the Shift Board in order of date. A user can look through the shift board at the scheduling needs and can open any shift. Once open, the details of the shift are illustrated.

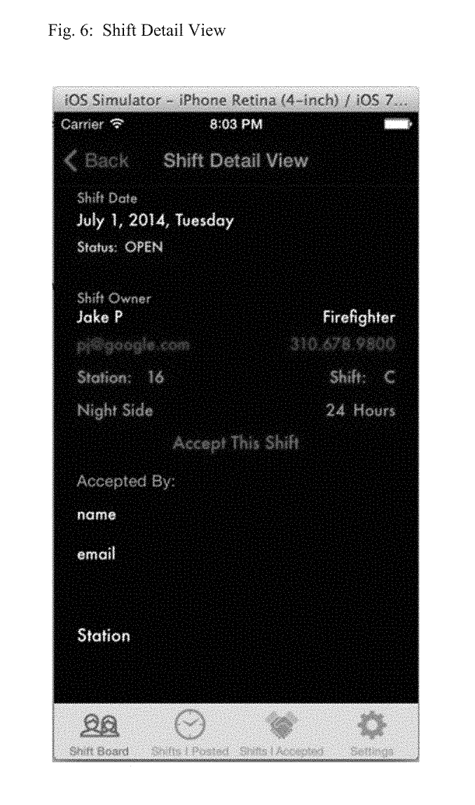

The details of the shift are based on the characteristics of need of the organization (FIG. 6). The basic characteristics of the scheduling needs that will always be present are: date, time (whether the scheduling need is morning, afternoon, or evening), duration (standard shift times: 8,10, 12, or 24 hours, or if another duration), and location (for both multi-location and single location organizations. Other features of the shift are customized by organizational company, business or industry need.

Included in the details of the scheduling need is the person who is offering up the shift, in the instance of trading, swapping. exchanging, and other types of coverage. In the instance of a supervisor offering a scheduling need, such as overtime scheduling, the supervisor or person creating the shift will be listed. The contact information for the individuals offering up the scheduling need are provided, both email and telephone number. Shift Trader allows for users to contact this individual via both methods to ask questions regarding the scheduling need, special instructions, or any other information, pertinent to the shift. As a scheduling need remains unaccepted it will be designated with “OPEN” (FIG. 6).

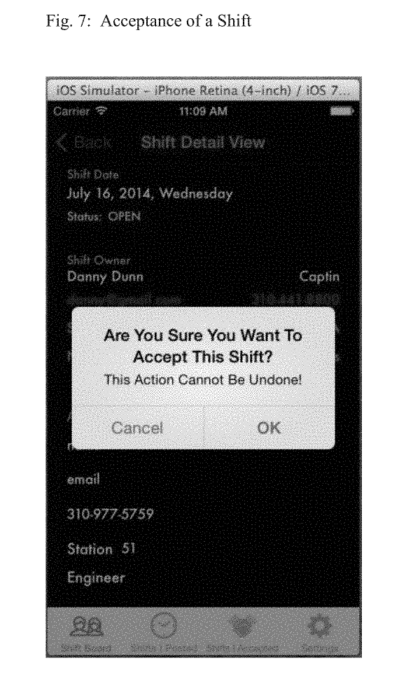

Once the user determines they want to accept the shift, they may press the “accept this shift” button (FIG. 7). A message will open, asking to confirm the acceptance of this shift. The user must press “Yes” for their request to be accepted by the application. If the user presses “cancel”, their request will not be uploaded. The acceptance of the shift is based on the profile characteristics, therefore, if there are multiple users who fit those specific parameters and all accept the shift, the application will determine who accepts the shift based on the first user to request the acceptance. In the case of seniority date, the app will determine the acceptance of the scheduling need based on those specific parameters.

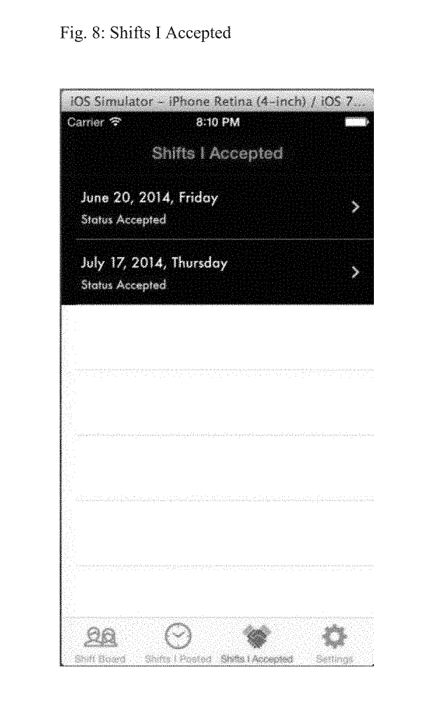

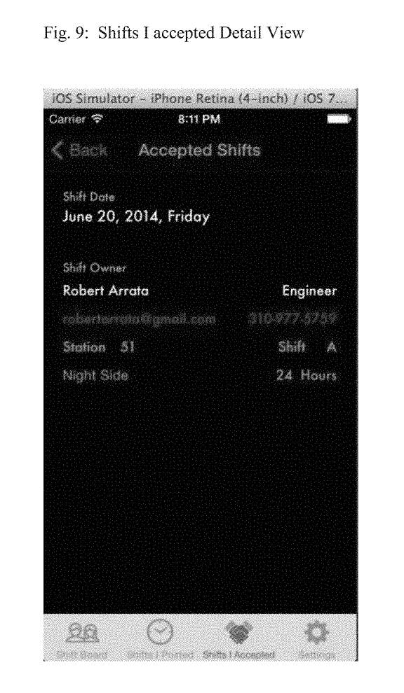

When a scheduling need is accepted, a message will be sent to the user that they have received the request. The accepted scheduling need is then sent to the “Shifts I've Accepted” page (FIG. 8). This feature allows users to keep track of and see their confirmed scheduling acceptances. The accepted scheduling change is also added to the user's calendar (FIG. 9). The detailed information regarding the accepted scheduling need will be included on the event details in the calendar. For both IPhone and Android versions the details of the scheduling need will be posted on the calendar in the format specific to the user's smart phone. Additionally, an alert is set up to remind the accepting user a day before the accepted scheduling need is to commence. For those organizations requiring specific scheduling paperwork, or communicating with a supervisor or other scheduling department, the details of the accepted scheduling need will be stored in the application so they may be detailed properly by the user by the appropriate channels (FIG. 9).

For those organizations where the scheduling need is placed onto the shift board by a supervisor or other scheduling body, where they determine who will receive the scheduling need, they application works in a similar way in that the user who has been granted their request will receive notification of the request being granted. The scheduling need will be similarly moved to the “Shift's I've Accepted” page and all the detailed information regarding that scheduling need will be contained therein (FIG. 8). At the point of acceptance of the scheduling need, “Open” will be replaced with “Closed” informing any other users the scheduling need is now unavailable.

For those users who have posted the scheduling need, they will receive a message that their posted scheduling need has been accepted by another user. The information. sent to the posting user, will include the contact information of the user accepting the scheduling need. This allows the posting user to contact the accepter and relay any details of the scheduling need, or if there are changes that take place prior to the scheduling need commencing, the ability to communicate between the both of them any issues.

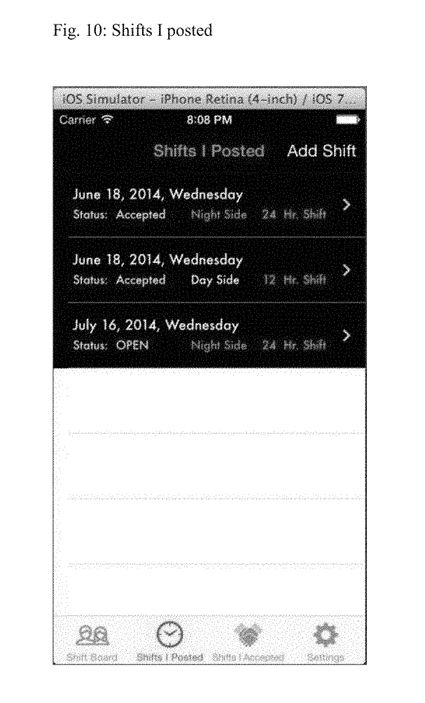

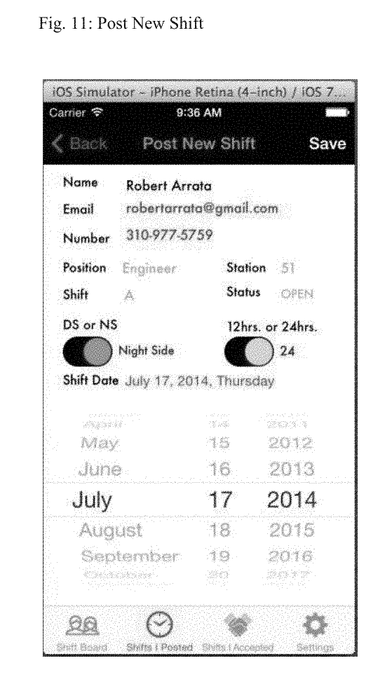

Users may post a scheduling need via the “Shifts I've Posted” page (FIG. 10). This page is detailed based on the user's organization and the scheduling change needed. As with the Shift Board postings, the standard required fields for the creation of a scheduling need are: date, time (morning/afternoon/evening), duration of the scheduling need, (shift standard based on 8,10, 12, 24 hours, or other customized duration range), location (for both organizations with solo or multiple locations), position, and specialized notes on the scheduling need itself (FIG. 11). The posting user's contact information will be automatically uploaded to the scheduling need creation via the profile.

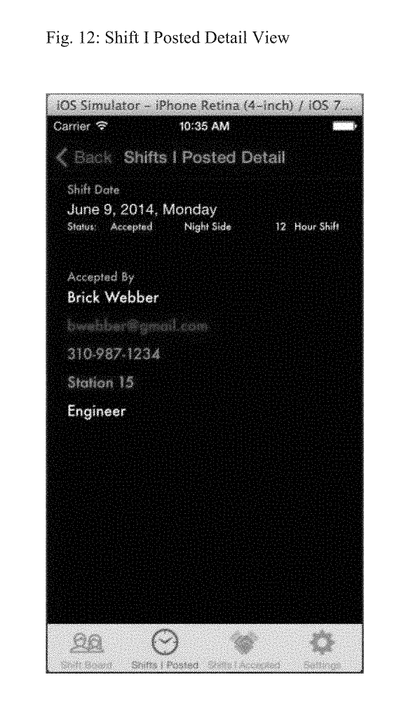

Once all the required fields are completed, the user will be required to press on “Save” at the upper right hand corner. A message will appear for confirmation the user wants to post this scheduling need. Once the posting user has confirmed the scheduling need by pressing “Yes”, the scheduling need is placed on the Shift Board and the posting user has the details of the scheduling need placed on the “Shift's I've Posted” page (FIG. 12).

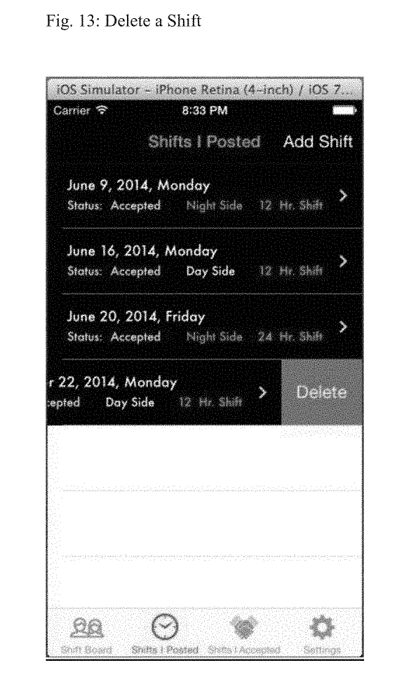

If a posting user decides they scheduling need is no longer applicable, they are able to delete the scheduling need (FIG. 13). The posting user must go to the “Shift's I've Posted” page of the application. Once on the page, the posting user must locate the scheduling need they want to delete on the page's list. To delete the scheduling need, the posting user must swipe their finger left across the scheduling need for the delete button to appear. Once the button appears, the posting user must select delete. After the posting user selects delete, the scheduling need will disappear from the “Shift's I've Posted” page, as well as the “Shift Board”.

### Construction

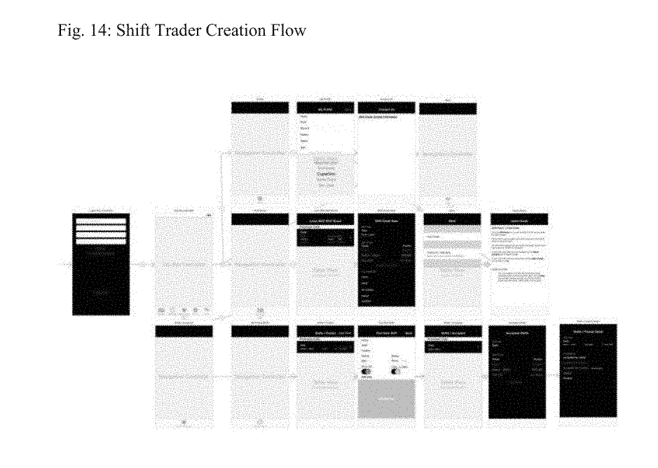

The following is a sudo code based on the described embodiment above. It is intended to be illustrative of specific applications of the present disclosure (FIG. 14). It would be impossible to list every potential application herein, however, other similar applications are within the spirit and scope of the present teaching. The code has been formatted to fit into USPTO appearance guidelines.

The foregoing description illustrates exemplary implementations, and novel features, of aspects of a mobile application, method and article of manufacture. Alternative implementations are suggested, but it is impractical to list all alternative implementations of the present teachings. Therefore, the scope of the presented disclosure should be determined only by reference to the appended claims, and should not be limited by features illustrated in the foregoing description except insofar as such limitation is recited in an appended claim.

While the above description has pointed out novel features of the present disclosure as applied to various embodiments, the skilled person will understand that various omissions, substitutions, permutations, and changes in the form and details of the present teachings illustrated may be made without departing from the scope of the present teachings.

Each practical and novel combination of the elements and alternatives described hereinabove, and each practical combination of equivalents to such elements, is contemplated as an embodiment of the present teachings. Because many more element combinations are contemplated as embodiments of the present teachings than can reasonably be explicitly enumerated herein, the scope of the present teachings is properly defined by the appended claims rather than by the foregoing description. All variations coming within the meaning and range of equivalency of the various claim elements are embraced within the scope of the corresponding claim. Each claim set forth below is intended to encompass any apparatus or method that differs only insubstantially from the literal language of such claim, as long as such apparatus or method is not, in fact, an embodiment of the prior art. To this end, each described element in each claim should be construed as broadly as possible, and moreover should be understood to encompass any equivalent to such element insofar as possible without also encompassing the prior art. Furthermore, to the extent that the term “includes” is used in either the detailed description or the claims, such term is intended to be inclusive in a manner similar to the term “comprising”.

The present teachings may be practiced with other system configurations, including hand-held devices, multiprocessor systems, microprocessor-based or programmable consumer electronics, network PC's, minicomputers, mainframe computers, and the like. The present teachings may also be practiced in distributed computing environments where tasks are performed by remote processing devices that are linked through a communications network. In a distributed computing environment, program modules may be located in both local and remote memory storage devices.

The embodiments described herein above may operate in a networked environment using logical connections to one or more remote devices. These logical connections can be achieved using a communication device that is coupled to or be a part of the computer; the present teachings are not limited to a particular type of communications device. The remote device may be a computer, a microprocessor, a server, a router, a network PC, a client, a peer device or other common network node, and typically includes many or all of the elements described above. The logical connections include a local-area network (LAN) and a wide-area network (WAN). Such networking environments are commonplace in office networks, enterprise-wide computer networks, intranets and the Internet, which are all types of networks.

When used in a LAN-networking environment, the computer is connected to the local network through a network interface or adapter, which is one type of communications device.

When used in a WAN-networking environment, the computer typically includes a modem, a type of communications device, or any other type of communications device for establishing communications over the wide area network, such as the Internet.

1-4. (canceled)

5. A system for enabling an employee to make changes in a employee schedule, comprising:
a mobile computing system, comprising:
a microprocessor element, operatively coupled to a memory storage device, wherein the mobile computing system is in electrical communication with a communications channel, operatively coupled to a database, wherein the mobile computing system is configured to render employee scheduling information on a display of a computational device;
a login screen, configured for a user to enter a username and password, thereby allowing the user to access and interact with the system;
an original schedule, having an original listing of employees scheduled for work, wherein the original schedule is posted on a shift board, wherein the shift board is available for viewing on the display of the computational device;
an employee's information, having a regular shift schedule, a skillset, a certification information, for each employee;
posting a scheduling need, by a posting user posting a scheduling change needed, and;
accepting the posted scheduling change needed, responsive to an accepting user accepting the posted scheduling change.

6. The system of claim 5, wherein the computational device is a mobile phone.

7. The system of claim 5, wherein the computational device is a tablet computer.

8. The system of claim 5, wherein the employee's information further comprises a seniority date.

9. The system of claim 5, further comprising a registration screen, configured for new members to set up their login registration information.

10. The system of claim 5, wherein the user is an employee.

11. The system of claim 5, wherein the user is a manager.

12. The system of claim 5, wherein the posted scheduling change needed is a shift.

13. A customizable employee profile system adapted for making changes in an employee shift schedule in an operating organization, comprising:
a mobile computing system, comprising:
a microprocessor element, operatively coupled to a memory storage device, wherein the mobile computing system is in electrical communication with a communications channel, operatively coupled to a database, wherein the mobile computing system is configured to render employee scheduling information on a display of a computational device;
a customized profile, configured for displaying on the display of the computational device, wherein the mobile computing system creates a plurality of parameters, allowing a user to view, post, create and accept a scheduling need, wherein the plurality of parameters are created based upon a specific characteristic for the operating organization;
a login screen, configured for the user to enter a username and password, thereby allowing the user to access and interact with the system;
an original schedule, having an original listing of employees scheduled for work, wherein the original schedule is posted on a shift board, wherein the shift board is available for viewing on the display of the computational device, and;
posting a scheduling need, by a posting user posting a scheduling change needed.

14. The system of claim 13, wherein the specific characteristic is an employee certification.

15. The system of claim 14, wherein the specific characteristic is a skill set.

16. The system of claim 15, wherein the specific characteristic is an employee position.

17. The system of claim 16, wherein the specific characteristic is a location.

18. The system of claim 17, wherein the specific characteristic is a seniority level.

19. A customizable employee profile system adapted for making changes in an employee shift schedule in an operating organization, comprising:
mobile computing means, comprising:
microprocessing means, operatively coupled to a memory storage means, wherein the mobile computing means is in electrical communication with a communications channel means, operatively coupled to a database means, wherein the mobile computing means is configured to render employee scheduling information on a display means of a computational device means;
customizable profile means, configured for displaying on the display means of the computational device means, wherein the mobile computing means creates a plurality of parameters, allowing a user to view, post, create and accept a scheduling need, wherein the plurality of parameters are created based upon a specific characteristic for the operating organization;
a login screen, configured for the user to enter a username and password, thereby allowing the user to access and interact with the system;
an original schedule, having an original listing of employees scheduled for work, wherein the original schedule is posted on a shift board, wherein the shift board is available for viewing on the display means of the computational device means, and;
posting a scheduling need, by a posting user posting a scheduling change needed.

20. The system of claim 19, further comprising accepting the posted scheduling change needed, responsive to an accepting user accepting the posted scheduling change.

21. The system of claim 20, wherein the mobile computing means is a mobile phone.

22. The system of claim 19, wherein the mobile computing means is a tablet computer.

23. The system of claim 20, wherein the mobile computing means is a tablet computer.

24. The system of claim 21, the posted scheduling change needed is a shift.
